(19) United States
(12) Patent Application Publication
(10) Pub. No.: US 2015/0159430 A1
(43) Pub. Date: Jun. 11, 2015

(54) Motorized Curtain and Blind Tracking Systems

(71) Applicant: Dazhi HUANG, Guangzhou, Guangdong (CN)

(72) Inventor: Dazhi Huang, Singapore (SG)

(21) Appl. No.: 14/380,745

(22) PCT Filed: Feb. 26, 2013
(86) PCT No.: PCT/CN2013/000186

§ 371 Date: Aug. 25, 2014

(30) Foreign Application Priority Data
Jul. 2, 2012 (AU) 2012900733

(51) Int. Cl. E06B 9/36

(52) U.S. Cl. CPC E06B 9/368

(57) ABSTRACT

Motorized curtain and blind tracking system (10) comprise control circuits (134), at least one either AC or DC motor (11) each with rotating output means (111), driving carrier (14), end cap pulley terminal (18) and driving terminal (13), and a completed looped belt (15) or cable (15) engaged with the end cap pulley terminal (18) and driving terminal (13), placed inside the track and engaged with the driving carrier (14). The driving terminal (13) comprises a housing (131) and driving pulley mechanism (132) which comprise a motor engaging means to fix said motor (11) with the driving terminal (13) and to couple with the rotating output means (111) for rotation to drive the belt (15) or cable (15) and also driving carrier (14) moving along the track. The driving terminal (13) comprises electrical connecting means to connect the motor (11) to ensure no wiring (120) is exposed, and identical motor engaging means to couple with same motor for various different tracking systems of curtain, vertical blind and panel curtain and etc. The driving terminal (13) further comprise control circuit (134) and clutch inside its housing (131) and this makes the motor (11) even more compact and neat to suit the applications where the motors are easily exposed particularly like rod curtain, vertical and panel curtain blind tracking systems. Further it is more possible to mount the motor on the top of the driving terminal inside ceiling due to its small size to perfect same applications.

### FIELD OF INVENTION

The present invention relates to motorized curtain and blind tracking system, either using AC or DC motor.

### DESCRIPTION OF RELATED ART

Current curtain and blind tracking systems cover drapery, vertical blind, panel curtain, art decor curtain rod tracking system etc, and all of them use different motors to adapt the different track and structure requirement. This ends up high cost of manufacture, logistic and stock management. Users who want to change different system need to buy new motor beside new track.

Current curtain and blind tracking systems cover drapery, vertical blind, panel curtain, art decor curtain rod tracking system etc, and all of them use different driving pulley terminals to engage with motor and adapt the different track and structure requirement. This ends up high cost of manufacture, logistic and stock management.

Current curtain and blind tracking systems cover drapery, vertical blind, panel curtain, art decor curtain rod tracking system etc, and all of them use different driving transmission cable or belt to adapt the different track and pulley structure requirement. This ends up high cost of manufacture, logistic and stock management. In particular of vertical blind tracking system, belt with hole must be used. Therefore it requires high positioning precision between the track, master carrier and belt to ensure reliable engagement between the holes and teethes. Further it requires cutting the belt to form a driving section to push the master carrier. This increase the manufacturing cost and strength of belt is jeopardized.

Current curtain and blind tracking systems, as above mentioned drapery, panel curtain, art decor curtain rod tracking system etc, and all of them use different master carriers to move tracking load to adapt the different track and structure requirement. It would be even more different if belt and steel cable are used for power transmission from motor torque to linear movement. This ends up high cost of manufacture, logistic and stock management. Users who want to change different system need to buy new motor beside new track.

One of curtain and blind tracking system, panel curtain blind tracking system, is always motorized by mounting additional motorized tracking system beside the manual tracking system. This ends up increasing cost, ugly and requirement of bigger installation space. Some design attempts to motorize the existing manual tracking system by building a motor and components into the latter. To adapt the current manual tracking system, the motor and related components must he special designed and made. This increase difficulties in manufacturing, logistic, stocking and selling processes. And further manual system is not very suitable for motorization, which limits its power force and hard for assembly.

One of curtain and blind tracking systems, vertical blind tracking system, is always motorized by modifying the existing manual operating tracking system. However, the manual system is not very suitable for motorization, which limits its power force and hard for assembly. Some totally standalone motorized vertical blind tracking systems have been developed but again they adopts totally different motors and components from those of other motorized curtain and blind tracking systems. This increase costs and difficulties in manufacturing, logistic, stocking and selling processes.

One of curtain and blind tracking systems, art decor curtain rod tracking system, is always motorized by modifying the existing manual operating tracking system and with motor being added in as an attachment. However, the manual system is not very suitable for motorization and modified manual system looks very ugly. Some totally standalone motorized art decor curtain rod tracking systems have been developed, but they having either problem as follows:
Different motors and components are adopted from those of other motorized curtain and blind tracking systems, or
Art decor rings as runners can not be used and decorative outlook thus is downgraded, or
Ring runners run on the top of track to lead to dust to go into track and sacrifice reliability

The driving pulley terminal connecting both the motor and track of current motorized curtain and blind tracking system only allows motor to be mounted from its bottom. This can not meet some high end interior design requirement of wireless and no-motor exposure. Although some driving pulley terminal can be allowed to turn upside down to achieve this end, but it needs to do some modification, and also this can not allow two motors to be mounted on both the top and bottom of the driving pulley terminal at same time to double the driving power.

The current motors for different types of motorized curtain and blind tracking system generally comprise gear motor, clutch for manual override operation and control circuit with either electronic or mechanic limit built inside the motor housing. This leads to very long structure, heavy and bulky body, and look ugly and impossible to upside down install them on the top of drive terminal for hiding motor inside ceiling due to ceiling height limit. This makes impossible and limit application scope for different types of motorized curtain and blind tracking system, in particular, the vertical blind system as the motor can not be mounted on the bottom of track.

The cable, remote control antenna and dry contact socket of the above mentioned motor are mostly placed together with its controller on the bottom of motor housing, and extended out from it to connect external power source or signals. This ends up wiring and cable are all exposed downward and very untidy and dangerous for children. Also extended cable adds the length and makes more impossible to install the motor on the top of track hided inside ceiling. A few motor designs build extra structure and space on the motor body to hide the thick high voltage cable and the other, and this ends up even bigger size of motor body and very hard and time consuming to make motor wiring connection during installation.

As limit sensors or switch of the above mentioned motor are placed near either output shaft of gear motor or clutch inside the motor housing, the pre-set limits lose in case of motor being taken down and reinstalled back. This results in not longer body of the motor, but also this requires resetting the automatic limits for opening and closing or the curtain or blind stop in wrong positions. Further because of this, there is big distance between electronic sensors and CPU control circuit, and thus wiring connected between the two has to go thru the motor and clutch with strong magnetic fields. The latter cause interference on sensor signal and make system operation not very reliable.

Current vertical blind tracking system use belt with holes and driving pulley comprises many sharp teeth to couple with it. This require high position precision and also sharp teethes are easily broken. To driving master carrier, the belt must be cut with a proper tool to form driving section to push the master carrier, and this leads to weaker strength of the belt and high production costs. Further connection for two ends of belt of the current system must be first assembling all carriers, track, belt and master and end pulley terminals and then done from inside of track with special connector and tool. It is very trouble some and high cost and lower reliability. With this connection two-way operation of vertical blind is impossible.

### THE OBJECT

The object of this invention is to provide a universal applicable motor and driving mechanism to be able to integrate with all types of motorized curtain and blind tracking system.

The object of this invention is to provide a universal applicable driving pulley terminal to be able to integrate with all types of motorized curtain and blind tracking system.

The object of this invention is to provide a common driving transmission belt or cable to be able to integrate with all types of motorized curtain and blind tracking system.

Another object of this invention is to provide a universal master carrier to be able to integrate with all types of motorized curtain and blind tracking system.

Another object of this invention is to provide a master carrier and belt engaging mechanism for vertical blind tracking system to be able to integrate with same type of driving transmission belt or cable to couple with same driving pulley terminal, thus same motor as above mentioned.

Another object of this invention is to provide an integrated motorized panel curtain tracking system comprising workable structure and driving mechanism to be able to engage, integrate with and adapt to the motor of all other motorized curtain and blind tracking system.

Another object of this invention is to provide an integrated motorized vertical blind tracking system comprising workable structure and driving mechanism to be able to engage, integrate with and adapt the motor of all other motorized curtain and blind tracking system.

Another object of this invention is to provide an integrated motorized art décor curtain rod tracking system comprising workable structure and driving mechanism to be able to engage, integrate with and adapt to the motor of all other motorized curtain and blind tracking system.

Another object of this invention is to provide a motorized curtain and blind tracking system with its driving terminal to allow motor to be mounted on the top. Also the driving terminal allow two motors to be mounted on both the top and bottom at same time, and its controller allows to drive two motor at same time to double the driving power.

Another object of this invention is to provide a motorized curtain and blind tracking system with a motor being compact and light in weight to make maximum possibility for upside down mounting inside ceiling and to best suit all type motorized curtain and blind tracking system.

Another object of this invention is to provide a motorized curtain and blind tracking system with its motor or power supply cable being not exposed on the bottom and its cable size being minimized inside it and not exposed externally at all.

Another object of this invention is to provide a motorized curtain and blind tracking system with its motor cable and controller being easily connected by the way of plug and play between them and to external power source and control signal.

Another object of this invention is to provide a motorized curtain and blind tracking system without resetting limit when motor is taken off and reinstalled back.

Another object of this invention is to provide a motorized curtain and blind tracking system with the distance between limit sensors and CPU control circuit is the shortest and placed far away from magnetic field of motor and electronic magnetic solenoid etc to enhance reliability.

Another object of this invention is to provide a motorized curtain and blind tracking system with its drive terminal comprising plug pins extended up and downward to allow its motor comprising receptacle pin to plug in from both bottom and top of drive terminal.

Another object of this invention is to provide a motorized curtain and blind tracking system with its drive terminal comprising a clutch for manual operation to reduce motor length.

Another object of this invention is to provide a motorized curtain and blind tracking system with its drive terminal comprising a controller to reduce motor length.

Another object of this invention is to provide a motorized curtain and blind tracking system with its drive terminal comprising a controller and clutch together to ensure blind and curtain position are always memorized even in manual operation and motor is taken off.

Another object of this invention is to provide a motorized vertical blind tracking system with an easily assembled belt driving means coupled with toothed belt to drive its master carrier and easily assembled connector for two ends of the belt to achieve two-way operation of the blind.

### BRIEF DESCRIPTION OF THE DRAWINGS

Now the present invention is described in the following with reference to the appended drawings, in which:

FIG. 1 is a front view of a motorized tracking system.

FIG. 2 is a fragmentary view of motorized tracking system with detailed components structure and assembly.

FIGS. 3, 4 and 5 is view of driving pulley terminal with various sectional views.

FIGS. 6, 7 ,8 and 9 are the front views of different polarity arrangement of male pins.

FIGS. 10, 11 and 12 are the views of the top cover for control circuit with male pin fixing and cover.

FIGS. 13, 14 and 15 are the views of the internal motor structure and its engagement with driving pulley terminals.

FIGS. 16, 17, 18 and 19 are views of top mounting of the motor to driving pulley terminals.

FIGS. 20, 21, 22 and 23 are views of the embodiment of clutch on driving pulley terminals.

FIG. 24 is a view of a motorized tracking system with special driving pulley terminals using cable.

FIGS. 25 and 26 are views of a motorized normal curtain tracking system.

FIGS. 27 and 28 are views of a motorized curtain tracking system with narrow width of track.

FIGS. 29 and 30 are views of a motorized curtain tracking system with steel cable and smaller track.

FIGS. 31, 32 and 33 are views of a motorized panel curtain tracking system and its special carriers.

FIGS. 34, 35 and 36 are views of a motorized rod curtain tracking system with finial.

FIGS. 37, 38, 39 and 40 are views of master carrier with different adapters for different motorized tracking systems.

FIGS. 40A, 41 and 42 are views of a motorized vertical blind tracking system.

FIGS. 43, 44, 45, 46 and 47 are views of carriers and its engagement with T shaped belt for a motorized vertical blind tracking system using same motor as one of above mentioned systems.

FIG. 48 is a view of spacing rope buttons for carries of motorized vertical blind tracking system.

FIGS. 49, 50 and 51 are views of the belt connector and its engagement and connecting with two ends of T shaped belt to form a complete loop for a motorized vertical blind tracking system.

FIGS. 52 and 53 are views of housing for power supply or controller for motorized tracking systems.

### DETAILED DESCRIPTION OF THE PREFERRED EMBODIMENT

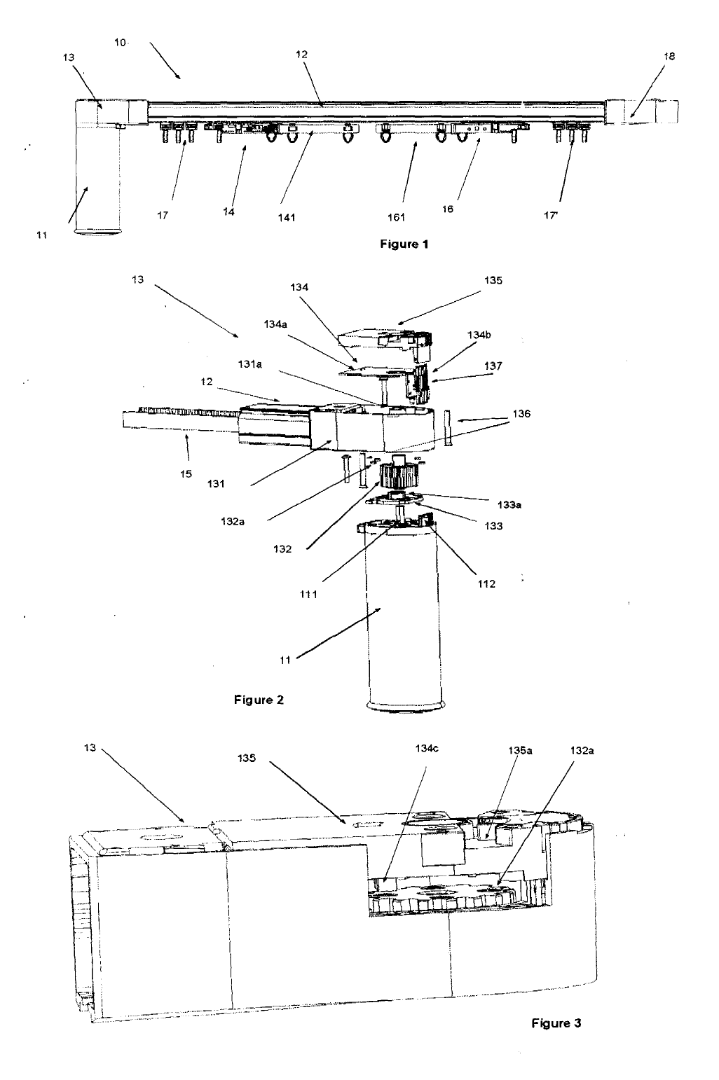

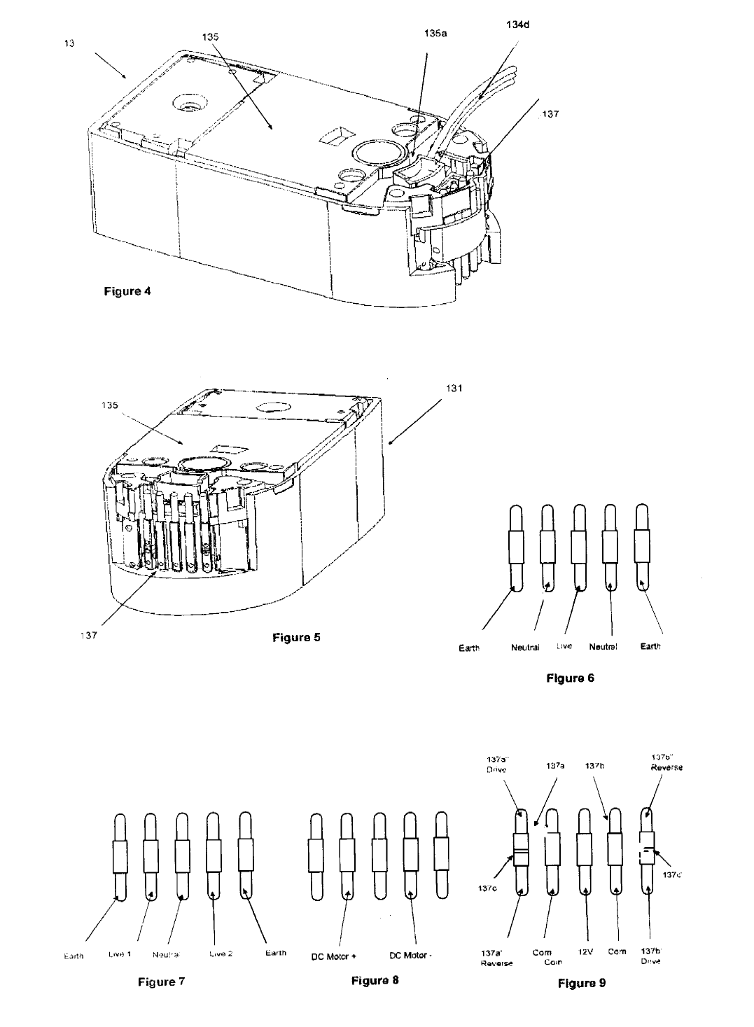

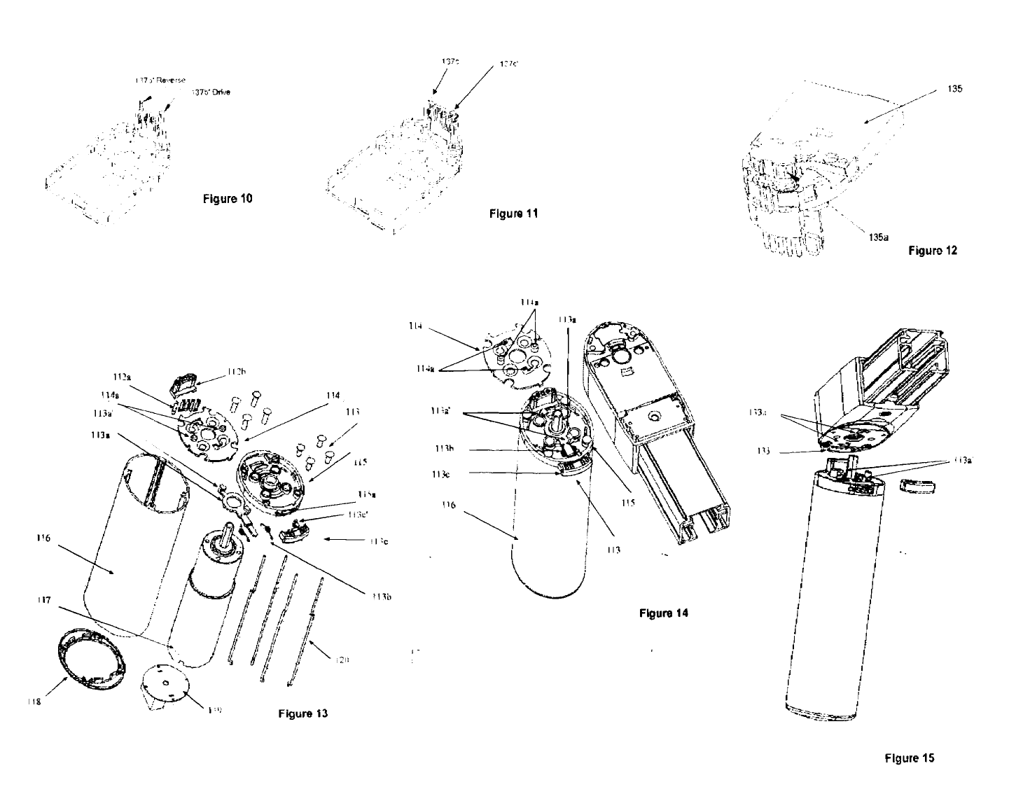

FIGS. 1 and 2 show a motorized curtain and blind system 10 comprising a motor 11 with output shaft 111 and plug connector 112, a piece of track 12, driving pulley terminal 13 with a housing 131, master carrier 14 engaged with a driving belt (or cable) 15 and secondary carrier 16 with series of carriers 17 and 17′ to follow them, and end cap pulley terminal 18. Both master carrier 14 and secondary carrier 16 comprise two holes to fix hanging bar 141 and 161 by two screws. A driving belt 15 also is engaged with master and secondary carrier 14 and 16 (not shown) are looped inside the track around the driving pulley terminal 13 and end cap pulley terminal 18. Motor 11 is engaged with driving pulley terminal 13 to rotate a toothed pulley 132 inside the latter to transfer rotating torque power to linear pulling force. Thus, when the motor 11 turns in one direction, it drives the master carrier 14 and secondary carrier 16 by belt 15 movement to move to the center of the track 12 (closing a curtain or blind), and when in the other direction, it drives the master carrier 14 and secondary carrier 16 to move to the two ends of the track 12 (opening the curtain or blind). In both situations, the carriers 17 and 17′ will follow the movement of the master carriers 14 and secondary carriers 15 one by one by curtain (not shown).

FIG. 2 shows driving pulley terminal 13 in further details comprising its housing 131 with a bearing hole 131a, a toothed pulley (for belt engagement) 132, bottom plate 133 with bearing hole section 133a, control circuit 134, and top cover 135 which holds and houses the control circuit 134. The toothed pulley 132 is inserted up to the bearing hole 131a and down to de bearing hole section 133a for rotation support. The output shaft 111 of motor 11 can be inserted into a hexagon shaped thru hole of toothed pulley 132 from its top and bottom. The shape of the shaft 111 can be any other shapes which must be identical and coupled with the hole shape of the toothed pulley 132 to be able to firmly engage with it.

Compared to the driving pulley terminal of conventional curtain and blind tracking system with its control circuit inside the motor, the control circuit 134 held by the top cover 135 is assembled together with the driving pulley terminal housing 131 by the screws 136 [symbol] circuit 134b thru which 5 male pins 137 are connected electrically.

FIG. 3 shows an assembled driving pulley terminal 13 with an opening view of its internal pieces of round shaped magnetic 132a are embodied. A sensor 134c weld on the bottom of PCB of the control circuit 134 is placed at reasonable distance to sense the rotating signal of the magnetic 132a. It is obvious to who is skilled in art shall easily program CPU to detect the signal of magnetic 132a for either limit setting, auto stop and auto start running of the curtain and blind tracking system 10.

The control circuit 134 can be structured in other way inside of driving pulley terminal housing 131 and sensor 134c may not necessarily be placed on the main PCB and can be separate circuitry to connect with a main circuitry with CPU.

As shown in FIGS. 3 and 4, the top cover has groove 135a which is used for electrical cable 134d to be laid out and extended out from the main PCB circuit 134a to outside of the driving pulley terminal 13 for connection of external power source or control signals.

As shown in FIGS. 4 and 5, the 5 male pins 137 are extended up and downward. The middle section of male pins 137 is square shape and the two ends of its top and bottom sections are round shape which can be mated with female plug connector 112 on the motor 11 as shown in FIG. 2. The two ends of the male pins 137 (as well as the mated female receptacles of the plug connector 112) can be other shape like square shape as long as it smaller in size than its middle section, and male pin and female plug can be exchanged and used on the motor 11 and driving pulley terminal 13 for same mating connection purpose. On the top cover 135 and bottom of housing 131 are 5 round holes respectively. When the top cover 135 together with control circuit 134 is assembled with the housing 131, two ends of male pins are extended out from the two rows of 5 round holes and the square shape of middle section of male pins 137 sits between the top cover 135 and bottom of housing 131. With this structure it is obvious that the male pins 137 are held firmly, even when the female plug 112 are plugged in and out, and with this structure, electrical connection to the motors 11 is possible when it is placed on the top aid bottom of driving pulley terminal 13 respectively or two of them are at same time.

Pin polarity arrangement shall be different as per different connection modes for top and bottom mounting of the motors 11 as follows:
1. FIG. 6 shows AC power connection with neutral, live and earth. In this application, the motor controller circuit must be placed inside motor 11. Among the 5 male pins 137, the center one is live. On the first left and right of the center pin is neutral. On the second left and right (outer left and right) is Earth. With this pin polarity arrangement, the motor connection with power source can be achieved when it is placed on either the top or bottom of the driving pulley terminal 13 individually without any circuit switching. However, this layout requires coordination in two control circuits for same rotation direction and synchronizing of two motors when two motors are placed on both top and bottom.
2. FIG. 7 shows AC control signal connection with neutral, live 1 for motor forward (or backward) running and live 2 for motor backward (or forward) running as well as Earth. Among the 5 male pins 137, the center one is neutral. On the first left and right of the center pin is live 1 and live 2. On the second left and right (outer left and right) is Earth. When two same motors are placed on the top and bottom of the driving pulley terminal 13, if the bottom motor turn clockwise, the top one will turn counter clockwise due to different pin polarity connection, i.e., Live 1 being changed to top motor backward running (or forward) and Live 2 changed for forward running(or backward). This ends up the toothed pulley 132 is driven in same direction by two motors on the top and bottom with opposite rotating direction. With this pin polarity arrangement, the motors connection with AC motor control signal can be achieved when it is placed on the top and bottom of the driving pulley terminal 13 either separately or at same time.
3. FIG. 8 shows DC motor direct control connection with DC motor forward and backward running polarity. In this case, only two pins are used and as same as AC control signal connection described above, two motors run in different rotating direction with opposite pin polarity connection when they are placed on the top and bottom. This ends up the toothed pulley 132 is driven by same direction by two motors on the top and bottom. With this pin polarity arrangement, the DC motors connection with DC motor direct control signal can be achieved when it is placed on the top and bottom of the driving pulley terminal 13 either separately or at same time.
4. FIG. 9 show DC motor control signal connection with 12V dc power supply, Com, motor drive signal and relay direction reverse signal. Among the 5 male pins 137, the center one is 12V dc power supply. On the first left and right of the center pin is Com. The second left 137a and right 137b (outer left and right) is split into two sections in this case. The second left pin 137a′on the bottom is motor relay direction reverse signal and right pin 137b′ of the bottom motor drive signal. The second left pin 137a″ on the top is motor drive signal and right pin 137b″ of the top is motor relay direction reverse signal. When two same motors are placed on the top and bottom of the driving pulley terminal 13, if the bottom motor turns clockwise, the top one of same motor will turn clockwise too. Therefore in this application, the top motor polarity terminal connection internally must be connected reversely compared to the bottom one. That means two motor are different. By this way the toothed pulley 132 can be driven by same direction by two different types of motors on the top and bottom. With this pin polarity arrangement, the motors connection with AC motor control signal can be achieved when it is placed on the top and bottom of the driving pulley terminal 13 separately or individually, but different types of motors are required for top and bottom mounting at same time. FIGS. 10 and 11 show how the split male pins 137a and 137b are assembled with 137a′ and 137b′ being inserted into the top cover first and then isolation spacer 137c and 137c′, and finally pin 137a″ and 137b″ are inserted (not shown).

FIG. 12 show on top section of 5 male pin 137 extended up on the top cover 135 is a connector cover 135a. This will protect and electrically isolate 5 male pins 137 from external environment when the motor 11 is not placed on the top of driving pulley terminal 13.

FIGS. 13, 14 and 15 shows internal structure of the motor 11 which comprises further locking mechanism 113, top plate 114 with 2 stop pins 114a, top cover 115, motor housing 116, gear motor 117, bottom cove 118, circuit 119 connected with motor terminal and wiring 120. The connector 112 has 5 female pins 112a sit inside connector plug 112b and are mated with male pins 137. The wiring 120 connects with female pins 112a and the circuit 119. In case of direct motor control of above described connection modes, the wiring 120 can be connected directly to the terminal of motor 11, saving the circuit 119. Locking mechanism 113 comprises rotating lock 113a with two protruded L shaped hooks 113a′, spring 113b, and handle 113c. The lock 113a sit in middle of the top cover 115 around its center shaft, and lock 113a, spring 113b and handle 113c are inter engaged as shown clearly in FIG. 14. On the top cover 115 there is slot 115a with one end bigger and the other smaller. On the top plate 114 are two holes 114b which allow protruded hook 113a′ extended out to hook the driving pulley terminal 13. FIG. 15 shows bottom plate 133 with corresponding notes 133a again for the hook 113a to be inserted in for locking of motor 11 and driving pulley terminal 13. The handle 113c comprises a protruding section 113c′ to be inserted in slot 115a. In the locking position of the motor 11 and driving pulley terminal 13, protruding section 113c′ sits in the bigger end of slot 115a and horizontal section of L shaped hook 113a′ sit on and against the top of bottom plate 133 thru the hole 133a. When one wants to unlock them, simply pull the handle 113c out and turn it to make protruding section 113c′ be out of bigger end and slide along its small end and at same time the horizontal section of L shaped hook 113a′ is shifted into hollow area of the hole 133a to unlock the motor 11 and driving pulley terminal 13.

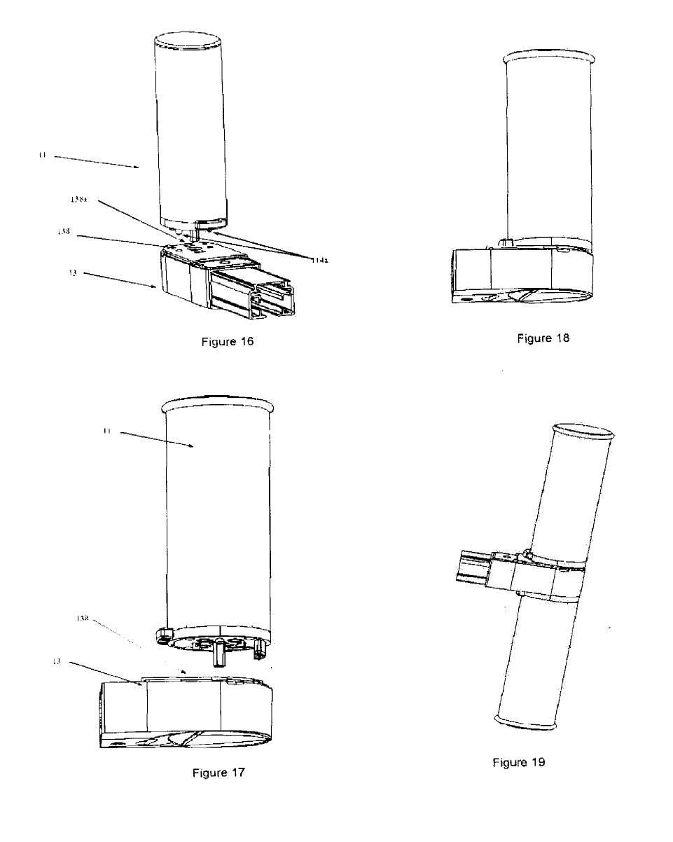

FIG. 16 shows the top plate 138 which comprises two same shaped holes 138a as the bottom plate 133 but offset position to it. This allows locking and unlocking the motor 11 to and from the driving pulley terminal 13 when the former is placed on the top of latter as shown in FIG. 17. In both locking position of both motor top and bottom placements, the 2 stop pins 114a is inserted into the two corresponding holes of top and bottom plate respectively to prevent the motor 11 from rotating around center axis to give further gripping strength.

With both above described pin polarity arrangement and locking mechanism, following results can be achieved as shown in FIGS. 18 and 19:
a. Motor total length can be shorter as there is no cable extended out from the bottom of motor
b. Motor connection with control signal or power source all can be made thru above described pin connector on its top, no any cable is extended out from the bottom. This make motor look neat and tidy.
c. Male pins and female plug connection makes motor ‘plug and play’ possible.
d. Motor can firmly and reliably be mounted at ease on the top and bottom of driving pulley terminal individually or at same time.

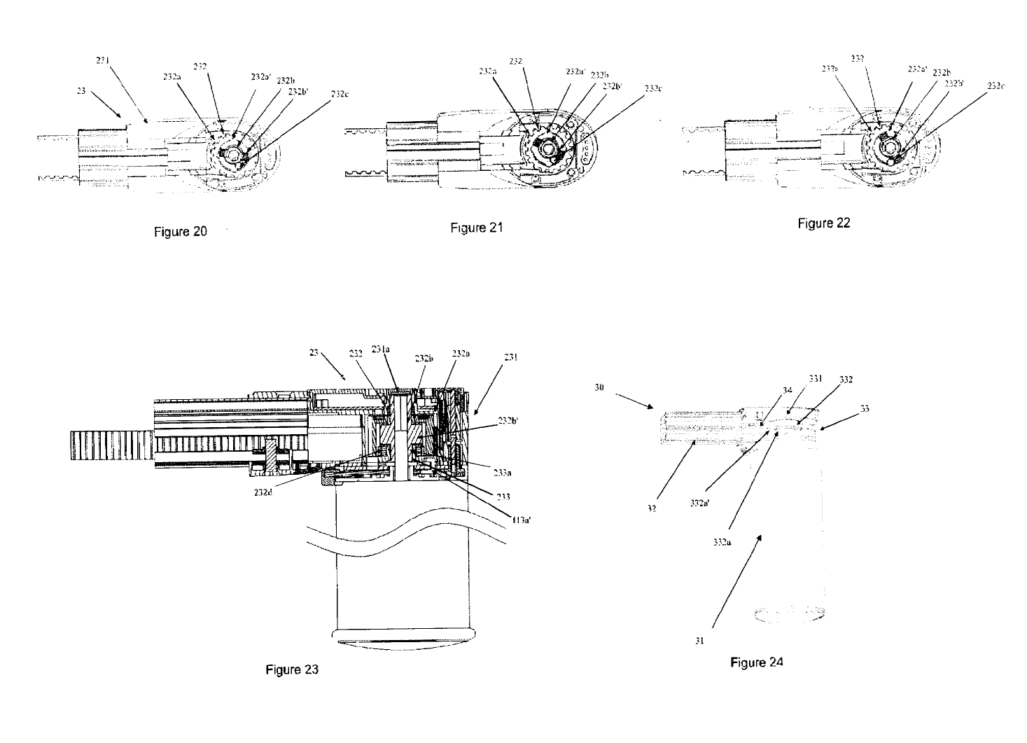

FIGS. 20, 21, 22 and 23 shows another embodiment of this invention with a driving pulley terminal 23 comprising a housing 231 and a pulley clutch mechanism 232. The pulley clutch mechanism 232 comprises toothed pulley 232a with round hollow section having 4 semi circle holes 232a′ around round edge, driving shaft 232b with a thru hole of hexagonal shape, cylinder shaped driving magnetic 232c, and pulley bearing 232d sitting around bearing hole section 233a of bottom plate 233 shown in FIG. 23. The semi circle holes 232a′ can be less than 4. The driving shaft 232b is placed inside of the toothed pulley 232a with its top section going up thru a top hole of toothed pulley 232a and to bearing hole 231a of housing 231, and down into bearing hole section 233a of bottom plate 233 for rotation support. On the middle of the driving shaft 232b are two driving member 232b′, which rotate with the driving shaft 232b to push driving magnetic 232c. The driving member 232b′ can be one only. The toothed pulley 232a sits around pulley bearing 232d and driving shaft 232b for its own rotation support. The output shaft 111 of motor 11 can he inserted into a hexagon shaped thru hole of driving shaft 232b from its top or bottom for rotating engagement.

FIG. 20 shows the driving shaft 232b is free position relative to 4 semi circle holes 232a′ and driving magnetic 232c. When the driving shaft 232b is rotated by motor shaft 111, the driving member 232b′ will push the driving magnetic 232c for rotation as shown in FIG. 21. Due to centrifugal force, driving magnetic 232c will tend to shift into one of 4 semi circle holes 232a′. As shown in FIG. 22 with part of its body being engaged with the toothed pulley 232 and another part is pushed against the driving member 232b′, thus the driving shaft 232a starts to push the toothed pulley 232a to turn for belt transmission. When one manual pull the master carrier 14 thru blind or curtain fabric fixed to it, the belt 15 will rotate the toothed pulley 232a to turn. If this rotation direction is moving the driving magnetic 232c away from the driving member 232b′, the toothed pulley will freely turn; If it moves the driving magnetic 232c against the driving member 232b′, it may be jammed and blocked by manually irreversible motor 11. This can be simply solved by a simple additional programming of motor controller, i.e., reverse turn by small angle after every time motor stops.

FIG. 23 also clearly show hook 113a′ of the motor 11 hook up of bottom plate 233 to lock the motor 11 with driving pulley terminal 23.

FIG. 24 shows alternative embodiment of tracking system 30 with same motor 31 as motor 11, track 32, driving pulley terminal 33 and steel cable 34. The driving pulley terminal 33 only shows top cover 331 and a pulley clutch mechanism 332. The toothed pulley 232a is replaced with steel cable pulley 332a. It comprises V shaped groove 332a′ on is middle to allow steel cable 34 sit in and turn around for torque transmission. All other structure and components are as same as those of driving pulley terminal 23 and will not be further described.

With the embodiment of pulley clutch mechanism inside driving pulley terminal, conventional placement of motor clutch for manual operation inside of motor will be changed to driving pulley terminal. Therefore the motor length is greatly reduced.

When the toothed pulley 232a and cable pulley 332a are equipped with same as round shaped magnetic 132a and sensor 134c, by proper programming of control circuit 134, the belt or cable position, i.e., master carrier position can be always registered and kept in controller memory, no matter when manual operation is going on, or motor is taken off etc. This is impossible for the conventional motors which have the controller inside their housing. This has developed great advantage over conventional motors.

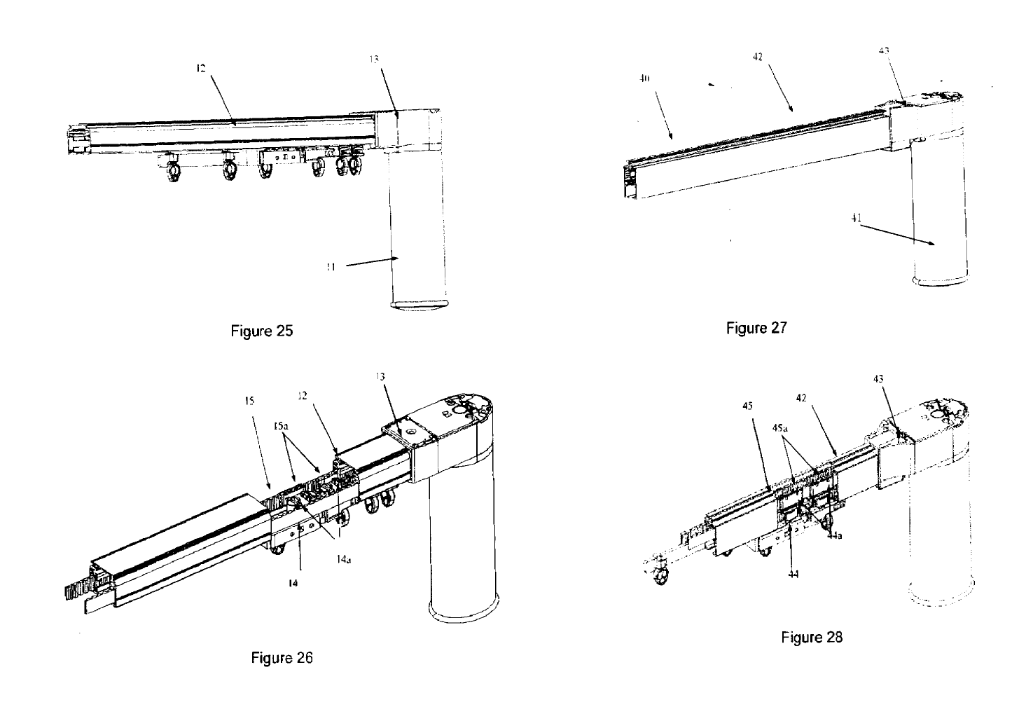

FIGS. 25 and 26 show cross section and outer profile of track 12 and how it fit into driving pulley terminal 13. One end of belt 15 goes into driving pulley terminal 13 and the other comes out from it. As shown in FIG. 26, the master carrier 14 comprises 2 adapters 14a thru which master carrier 14 is engaged with the belt 15 by two belt connectors 15a. The belt connector 15a be fixed with belt on one end and the other is protruded out and inserted into the hole of adapter 14a horizontally. Therefore the linear movement of belt 15 (driven by motor 11) will push the master carrier 14, and then the latter pull the curtain which hang on it (not show). This structure of the tracking system is very much conventional curtain tracking system.

FIG. 27 show another tracking system 40 with a motor 41 same as the motor 11 and narrow width of track 42 which allow track installer to manually bend it on site as per curved window shape. The driving pulley terminal 43 is of mostly same structure on the bottom to engage with same motor 41, except that its front is shaped into narrow gradually to allow the track 42 to insert in tightly. All other parts of the driving pulley terminal 43 are same those of driving pulley terminal 13 and will not be further explained.

To match the narrow track 42, as shown in FIG. 28, the master carrier 44 comprises narrow adapter 44a which be fixed together by screws. The belt 45 has connector 45a which is fixed to the belt 45 in same way but vertically is inserted into top hole of the adapter 44a. The difference of two master carriers 14 and 44 is their adapter 14a and 44a, and other structure is same.

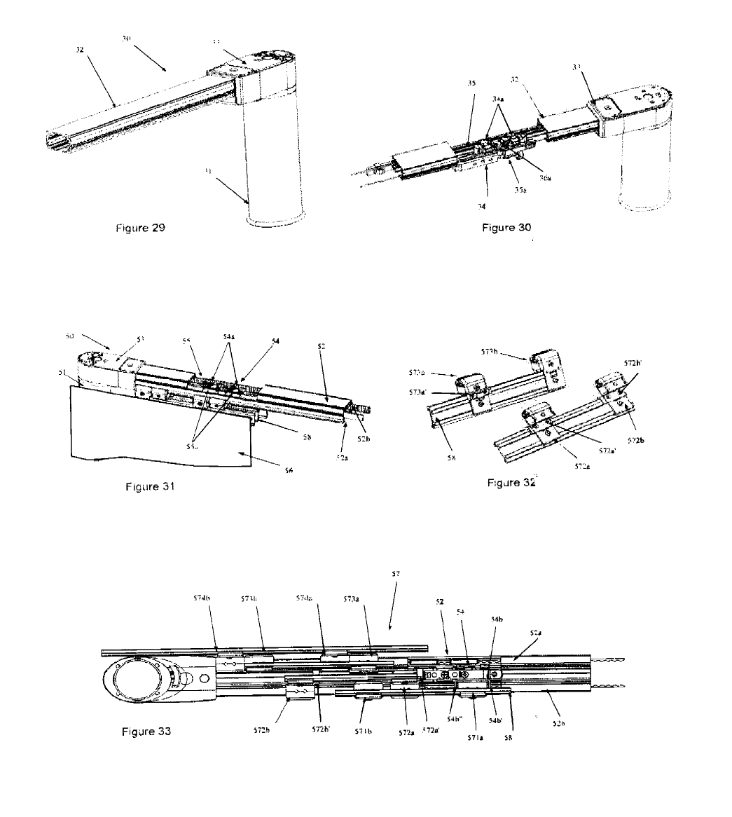

FIG. 29 show cross section and outer profile of track 32 in tracking system 30 and how it fit into driving pulley terminal 33 which has same structure on the bottom to engage with a motor 31 same as the motor 11, except that its front is shaped into narrow gradually to allow the track 32 to insert in tightly. All other parts of the driving pulley terminal 33 have been described in FIG. 24. As shown in FIG. 30, the master carrier 34 comprises 2 adapters 34a which guides and channel the steel cable 35 to two cable fastener 35a (only one shown). The two steel cable fasteners 35a fix two ends of steel cable on master carrier 34. Secondary carrier (not shown) which is same structure as the master carrier 34 but with center steel cable fasteners 36a to fix another side of steel cable 35 for two way curtain operation. This is common structure of this type of curtain system, thus it will be further described.

FIGS. 31 , 32 and 33 show one-way panel curtain tracking system 50 with a motor 51 same as the motor 11 and special track 52 with two T sections 52a and 52b on its bottom. The special track 52 again is inserted to the driving pulley terminal 53 which is of exactly same structure as those of driving pulley terminal 13, not only on its bottom to engage with a motor 51, but also all other parts inside the driving pulley terminal 53, and therefore will not be further explained.

As shown in FIG. 31, the master carrier 54 comprises a same adapter 54a as the adapter 14a which he fixed together by screws. By fully same driving engaging way as the master carrier 14 and belt connector 15a, the belt 55 has two connectors 55a which are fixed to the belt 55 on one side and the other end is inserted into the hole of the adapter 54a horizontally. The secondary carrier (not shown) is same and will not further be explained. As shown in FIG. 31 fabric panel 56 is the load of tracking system 50 compared to curtains in above mentioned systems.

As shown in FIG. 33, 4 sets of carrier 57 move along the track 52 of which one end is inserted into the driving pulley terminal 53 and other end cap pulley terminal (not shown). The first set comprise one carrier 571a and 571b, the second set comprise one carrier 572a and 572b, the third set comprise one carrier 573a and 573b, the fourth set comprise one carrier 574a and 574b. Each set holds one curtain panel track 58 to hold one piece of curtain fabric 56 (normally Velcro tape is used), compared to many carriers 17 or 17′ in curtain tracking system 10. The T section 52a forms moving support base for carriers 57 which comprise a corresponding T shaped slot couple with the shape of T section 52a. First sets and second set move along T section 52b, and the third and fourth set move along T section 52a. The carrier 571b is placed behind or next to the carrier 572a Therefore when the first set move toward center of track 52, the carrier 571b will pull 572a of the second set toward same direction, and when it moves backward, the carrier 571a will push carrier 572a in backward direction too. Same pulling and push direction can be achieved with same arrangement of the third and four set. As shown in FIGS. 32 and 33, to make all four sets move in same direction by pulling and push one by one, carrier 572b comprises driving link 572b′ mounted with two screws onto it to engage and pull driving section 573a′ mounted with two screws on the carrier 573a to the center. Carrier 572a comprise driving link 572a′ mounted with two screws onto it to engage and push driving section 573a′ in backward direction too. The master carrier 54 is mounted with an U shaped pusher 54b (to replace hanging bar 141 and 161 in master carrier and secondary 14 and 16 of tracking system 10) which is placed to just hold the carrier 571a with its two flange 54b′ and 54b. When the master carrier 54 moves to the center the flange 54b″ will pull the carrier 571a in same direction, and when it moves backward the flange 54b′ will push the carrier 571a in same direction too.

FIG. 32 shows detailed structure of carrier 573a with the driving section 573a′ and 573b, as well as carriers 572a and 572b with their driving link 572a′ and 572b′. FIG. 32 further shows how panel track 58 to be mounted with a screw to the holding section of these carriers. 573a and 573b have mounting orientation in relation to the panel track 58 opposite to carrier 572a and 572b. As shown in FIG. 33, carrier 573a and 573b is identical to 571a and 571b in terms of structure and mounting orientation in relation to the panel track 58, and carrier 572a and 572b is identical to 574a and 574h in terms of structure and mounting orientation in relation to the panel track 58.

By above described arrangement, the motorized panel curtain tracking system 50 achieves open and close operation on one piece of track and by same motor 51 and driving pulley terminal 53 as the motor 11 and terminal 13. With same arrangement the another 4 sets of carriers can be placed on carrier 57 to achieve same function but only move in opposite direction to achieve two way open and closing operation of panel curtain. The system in actual application may be less than 4 sets, and in two way situation two sides may not have same number of sets. Nonetheless, above mention purpose can still be made.

FIGS. 34 and 35 show rod curtain tracking system 60 with a motor 61 same as the motor 11 and round shaped track 62. The driving pulley terminal 63 comprises bottom housing 631 with mainly same structure on the bottom to engage with same motor 61. The difference is that its front is shaped into round shape gradually to allow the track 62 to insert in tightly and its top cover 632 is also semi round shaped to be streamlined with the whole system outlook. On the rear of the driving pulley terminal 63 is cylinder shaped base 63′ to allow decorative finials to be inserted horizontally into with a spacer adapter 633a or 633b, which have same inner diameter and different outer diameters. On the cylinder shaped base 63′ is a round hole 63″ and adapter 633 also has hole 633a′ and 633b′on corresponding position. After the adapter 633a or 633b is inserted onto the cylinder shaped base 63′ it will be fixed with a screw (not shown) which is sunk below its surface. This way allows different inner diameters of decorative finials tightly fit in with different outer diameter of the adapter 633a, 633b or others. All other parts of the driving pulley terminal 63 are same those of driving pulley terminal 13 and will not be further explained.

As shown in FIGS. 34 and 35, the master carrier 64 comprises same adapter 64a as adapter 14a which be fixed together by screws. The belt 65 has same connector 65a as connector, 65a which is fixed to the belt 65 in same way on one side and the other horizontally is inserted into hole of the adapter 64a. The difference is the master carrier 64 comprises 2 ring holding holes 64b to allow decorative rings 66 with a protruded section to insert the holes 64b for fixing with it. And further carriers 67 comprise also same shaped ring holding hole (not shown) again for same purpose to allow decorative rings 66 to fix into it.

FIG. 36 show another embodiment of the rod curtain tracking system with same master carrier 64 which hold smooth rings 66′. It has slot 64c (all other master carriers have same slot) to allow fixing bracket 64d of similar type of conventional smooth ring manual rod curtain system to integrated together to firmly fix the two smooth rings (only one shown).

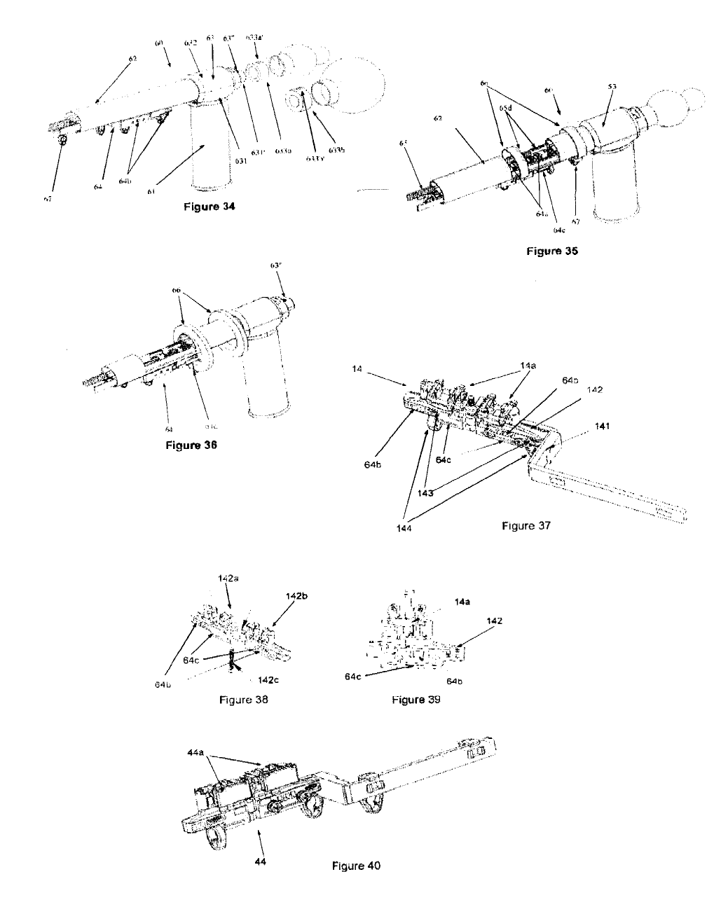

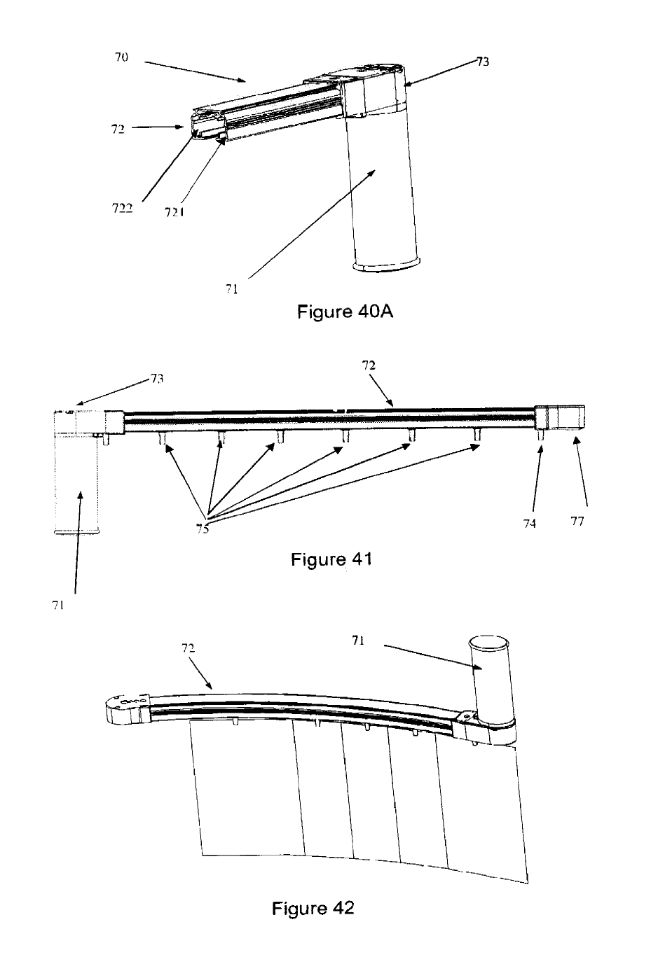

FIG. 37 shows detailed structure of above described master carrier 14 which comprises hanging bar 141, two adapters 14a, and main body 142 with two holes for hanging bar 141 fixing with two screws. It further comprises engaging holder 143 for hook rings 144 useable for both curtain hooks and ripple fold buttons. The main body 142 can be made either in complete piece, or separately in two pieces 142a and 142b and connected together by a shaft 142c to form a chain structure as shown in FIG. 38. FIG. 39 shows how an adapter 14a is fixed into the main body 142 by a screw or rivet. Chained master carrier is good for curved tracking, in particular, the master carrier 44 in curtain tracking system 40 as shown in FIG. 28. It can be seen clearly in FIG. 40 the adapter 44a has opening on the top not on two sides (blocked) to allow vertical engagement with connectors 45a. From all the figures can be seen that the master carrier 54 comprise same structured main body and adapter, except that same two holes for fixing hanging bar 131 are used for fixing U shaped pusher 54b. Further the master carrier 64 comprise same structured main body and adapter as those of the master carrier 14, on which holes 64b are used to fix decorative rings 66 and slot 64c are used to fix smooth ring bracket 64d.

As per above described, it can be seen clearly that the master carrier can be very identical and one only need adding one component and another to meet all requirement of above described curtain and blind tracking systems.

FIGS. 40 and 41 show one-way vertical blind tracking system 70 with a motor 71 same as the motor 11, track 72 with two belt channel 721 and 722, master carrier 74 and normal carriers 75. The track 72 again is inserted to the driving pulley terminal 73 which is of exactly same structure as those of driving pulley terminal 13, not only on its bottom to engage with a motor 71, but also all other parts inside the driving pulley terminal 73, and therefore will not be further explained.

FIG. 42 show shows one-way vertical blind tracking system 70 with a motor 71 mounted on the top of the driving pulley terminal 73 and blind vanes hangs on both master hook 74 and normal hooks 74 below the track 72. This shows another advantage of mounting motor on the top of vertical blind track as vertical blind can fully cover the window without motor block blind vane turning operation.

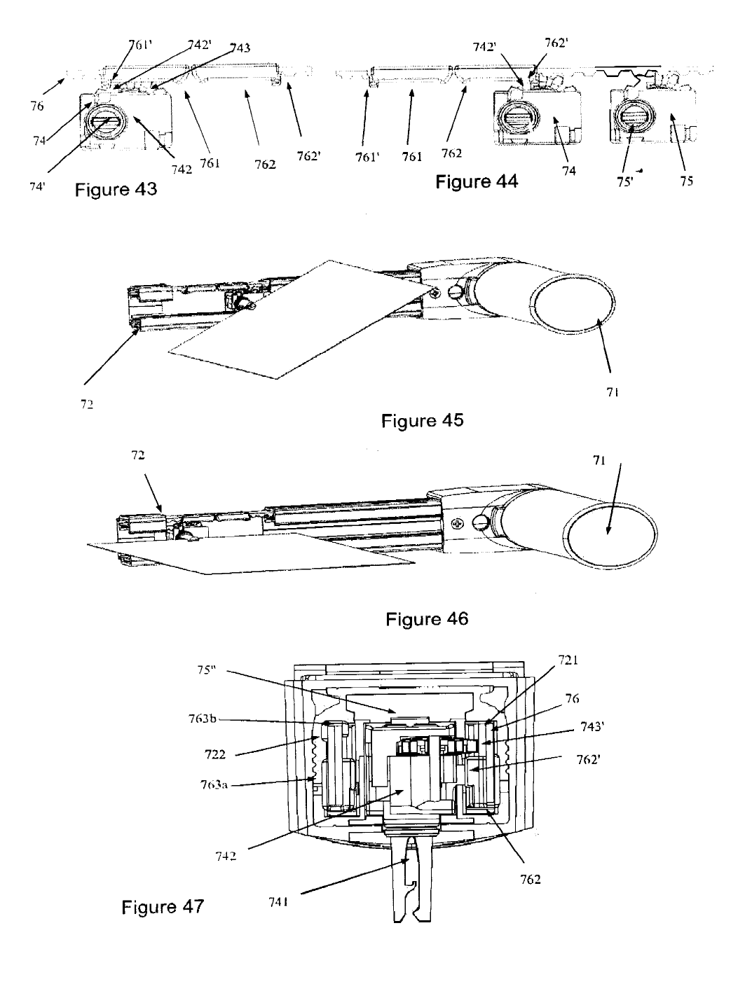

FIGS. 43, 44, 45, 46 show how master carrier 74 operates vertical blind system 70 with toothed driving belt 76 movement thru driving pulley terminal 73 by motor 71 turning torque. Master carrier 74 is same as current and conventional master carrier of vertical blind systems and comprises hook 741, supporting body 742, and gear mechanism 743 inside supporting body 742. FIGS. 43, 44, and 47 does not show the internal section of the gear mechanism 743 but only a belt engaging gear 743′ on its top, which is engaged with toothed driving belt 76. The gear mechanism 743 has proper gear transmission ratio so that when belt engaging gear 743′ rotates certain numbers of turns, the hook 741 will turn a required angle to turn blind vanes from opening to closing position as shown in FIGS. 45 and 46. As this is currently popularly used design, who is skill in this the art will easily decide on the gear transmission ratio and internal gear transmission mechanism, these will not be further described. The difference of this embodiment from the convention master carrier is teeth shape of the belt engaging bear 743′. Conventional one use belt with hole so that the teeth shape is sharp enough to be inserted to the hole to engage with the belt while that of the belt engaging gear 743′ couples with teeth shape of toothed belt, in other term, T belt or synchronized belt. Further the conventional one requires high positioning precision between the track, master carrier and belt to ensure reliable engagement between the holes and teethes, but teeth driving belt 76 and the belt engaging gear 743′ are much less.

On the belt 76 are two belt driving blocks 761 and 762, each of which comprises pushing section 761′ and 762″ and exact same internal shape as teeth of driving belt 76 for coupling each other so that it can be inserted into the toothed driving belt 76 for driving engagement inside belt channel 72 I as shown in FIG. 47. On the supporting body 742 comprising driving section 742′ protruding out toward to belt 76. The pushing section 761′ and 762′ protrude out to engage with driving section 742′ for forward and back driving movement.

FIG. 43 shows the pushing section 761″ is pushing against to left side of the driving section 742′ for purpose of open vertical blind vanes and also relative open position between the two at the moment of blind stop. FIG. 44 shows the pushing section 762′ is pushing against to right side of the driving section 742′ for purpose of closing vertical blind slabs and also relative closing position between the two at the moment of blind stop. When motor 71 drives the belt 76 from closing position of vertical blind as shown in FIGS. 44 and 46 to open it rightward, firstly belt driving blocks 761 and 762 are moving rightward and at same time belt engaging gear 743′ is rotated by the belt 76 clockwise. Therefore the blind vanes are rotated to open position as shown in FIG. 45. Once the pushing section 761′ touch and push driving section 742′ and the master carrier 74 is moving rightward so that the blind vane will be pushed to rightward for blind opening. When motor 71 drives the belt 76 from open position of vertical blind as shown in FIGS. 43 and 45 to close it leftward, firstly belt driving blocks 761 and 762 are moving leftward and at same time belt engaging gear 743′ is rotated by the belt 76 counter clockwise. Therefore the blind vanes are rotated to closing position as shown in FIG. 46. Once the pushing section 762′ touch and push driving section 742′ and the master carrier 74 is moving leftward so that the blind vane will be pushed to leftward for blind closing.

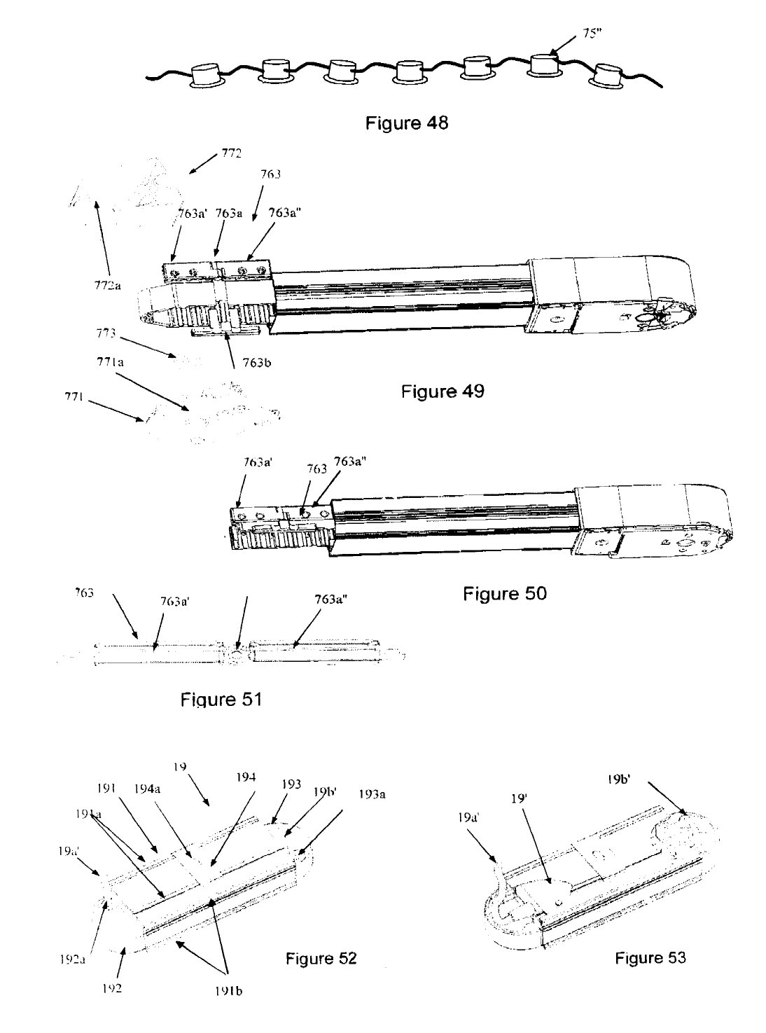

The normal carriers 75 are totally same structure as the master carriers 74 except that these have not the protruding driving section 742′. On the top of both master carrier 74 and normal carriers 75 are holes 74″ and 75′ which allow spacing rope buttons 75″ as shown in FIG. 48 to clip into them to pull them one by one for closing purpose and space out the carriers, thus blind vanes with even distance in closing position.

FIGS. 49 and 50 show belt connector 763 of vertical blind tracking system 70 comprising belt connector 763a and connector lock 763b. The belt connector 763a has same teeth shape as that of belt 76 and can be inserted into and coupled with two ends of the belt 76 from one side of the belt 76 to allow the belt 76 to form a complete loop, and then connector lock 763b is inserted into connector 763a to lock two ends of belt 76 and connector 763a together. Locking mechanism between the connector 763a and 763b simply apply conventional clip structure by material elasticity. As belt movement channel inside track 72 is small enough and no room for unlocking of the two and thus locking mechanism can be reliable. The belt connector 763 can be one complete piece or separated into two pieces, the right section 763a′ and left section 763a″. As shown in FIGS. 49, 50 and 51, the right section 763a′ and left section 763a″ are chained with shaft 763c in middle. With this structure the belt connector 763 can move around in curved track 72 smoothly without jamming.

FIG. 49 also shows end pulley terminal 77 comprising top cover 771, bottom cover 772 (top and bottom is position relative to installation position and the Figure shows only assembly position) and toothed pulley 773. On both top and bottom cover 771 and 772 are bearing hole 771a (the back of the actual holes is shown only) and 772a to support toothed pulley 773 for rotation. After two ends of belt 76 is locked by belt connector 763, firstly toothed pulley 773 is inserted into the bear hole 771a of top cover 771, and then the top and bottom cover 771 and 772 are assembled together and fastened by screws (not shown) with the other end of the toothed pulley 773 being inserted into the bearing hole 772a.

As can be seen in FIG. 47, the belt connector sits in and moves forward and backward inside of belt channel 722 of track 72 without touching the carriers. As belt connector 763 is assembled and locked with belt 76 outside track 72 before inserting end pulley terminal 77, it makes possible for two way vertical blind system by one complete belt loop, compared to the current system design which only can do one way. The current system requires that the end pulley terminal is inserted into track first and two ends of belt are connected with a connector inside belt channel of track with special tool.

The embodiment of above described vertical blind tracking system 70 does not use same master carrier as that of previously described systems, but it can be coupled and engaged with same type of toothed driving belt so that same driving pulley terminal can be used, thus same motor can be used too.

FIGS. 52 and 53 show a housing 19 for DC power supply or external motor controller for the purpose of hiding theses to achieve wireless motor outlook. The housing 19 comprises main body 191, left cover 192 with cable outlet hole 192a and left cover 193 with cable outlet hole 193a, which can be identical or different shaped or structure. As shown in FIG. 53, a power supply 19′ comprising AC inlet cable 19b′ and DC output cable 19a′ is placed inside housing 19. On two outer sides of the main body 191 are two sets of L shaped flanges 191a and 191b. One or more installation brackets 194 (only one shown) are provided which comprises a hole 194a for screw mounting onto the ceiling or wall etc. The bracket 194 clips in to flanges 191a or 191b to hold the housing 19, thus power supply 19′. AC inlet cable 19b′ is extended out from cable outlet hole 193a and DC output cable 19a′ is extended out from cable outlet hole 192a. Alternatively DC output cable 19a′ is placed through inside housing 19 and extended out from cable outlet hole 193a or AC inlet cable 19b′ is placed through inside housing 19 and extended out from cable outlet hole 192a. Mounting the housing 19 may use other ways than that by L shaped flanges 191a and 191b with the bracket 194.

When motor controller is placed inside housing 19, its inlet and outlet cable can do same as above described and will not be further described. The housing 19 can be mounted just beside of above mentioned driving pulley terminals, and electrical cable 134d, either control cable or power supply cable, as shown in FIG. 4 can enter the housing 19 thru either the hole 192a or 193a by proper connector with either power supply 19′ or motor controller. By this way, all able and connector can be placed inside the housing and will not be exposed at all.

With this invention thus explained, it is apparent that numerous modifications and variations can be made without departing from the scope and spirit of this invention. It is therefore intended that this invention be limited only as indicated in the appended claims.

I claim:

1. A motorized curtain and blind tracking system comprising control circuits, a least one motor each with rotating output means, driving carrier, end cap pulley terminal and driving terminal, a track with its two ends being connected with said end cap pulley terminal and driving terminal, and a completed looped belt or cable engaged with said end cap pulley terminal and driving terminal, placed inside said track and engaged with said driving carrier, said driving terminal comprising a housing and driving pulley mechanism, said driving pulley mechanism comprising motor engaging means to fix said motor with said driving terminal and to couple with said rotating output means for rotation to drive said belt or cable and also driving carrier moving along the said track, said driving terminal comprising electrical connecting means to connect said motor.

2. A motorized curtain and blind tracking system according to claim 1, wherein part or whole of said control circuits is placed inside said driving terminal and comprise outlet cable extended out from said driving terminal.

3. A motorized curtain and blind tracking system according to claim 1, wherein said control circuits comprise power supply, sensors, main circuits and casing comprising cable hole, wherein said power supply is housed inside said casing and both are together placed independently; wherein said main circuits is placed in said driving terminal and comprises outlet cable extended out from said driving terminal to connect with said power supply thru said cable hole; wherein said sensors are connected with said main circuit.

4. A motorized curtain and blind tracking system according to claim 2, wherein said driving terminal comprises at least one sensing means rotating together with said driving pulley mechanism to be coupled with said sensors.

5. A motorized curtain and blind tracking system according to claim 2, wherein said driving pulley mechanism further comprises a pulley engaged with said belt or cable and clutching means for its disengagement of said pulley from the motor.

6. A motorized curtain and blind tracking system according to claim 5, wherein said pulley comprises a round hole in its center and clutching means comprises a driving shaft engaged with said rotating output means and being rotated inside said hole, and said driving shaft comprises pushing member to drive said pulley via a magnetic cylinder being sit into at least one semi circle groove on internal wall of said round hole for rotation, and said magnetic cylinder is moved away from said semi circle groove for disengagement between said pulley and driving shaft when said pulley is rotated via said belt or cable by said driving carrier being pulled by external force.

7. A motorized curtain and blind tracking system according to claim 2 and 3, wherein said driving terminal further comprises controller box and said control circuits or main circuit is placed inside said box, and both together then are placed inside said driving terminal;

8. A motorized curtain and blind tracking system according to claim 2 and 3, wherein said driving terminal comprises cable groove for said outlet cables to be laid inside it.

9. A motorized curtain and blind tracking system according to claim 2 and 3, wherein said control circuits or main circuits comprise vertical and horizontal circuits being electrically connected together.

10. A motorized curtain and blind tracking system according to claim 1, wherein said control circuits comprise a controller casing and are together placed independently; wherein said control casing houses said control circuits and comprise cable hole, and said controller circuits further comprise outlet and inlet cables extended out and in from said cable hole to connect with said motor via said electrical connecting means.

11. A motorized curtain and blind tracking system according to claim 3 and 10, wherein said control casings comprise bracket mounting flanges and bracket for mounting independently.

12. A motorized curtain and blind tracking system comprising at least one motor each with rotating output means, driving carrier, end cap pulley terminal and driving terminal, a track with its two ends being connected with said end cap pulley terminal and driving terminal, and a completed looped belt or cable engaged with said end cap pulley terminal and driving terminal, placed inside said track and engaged with said driving carrier, said driving terminal comprising a housing and driving pulley mechanism, said driving pulley mechanism comprising 2 sets of motor engaging means with the first set being on the top and the second set on the bottom of said driving terminal to fix said motor, and having common driving transmission means to couple with said rotating output means on bottom & top of said driving terminal for rotation to drive said belt or cable and also driving carrier moving along the said track

13. A motorized curtain and blind tracking system according to claim 12, wherein said driving pulley mechanism further comprises one pulley engaged between said driving transmission means and belt or cable, and one clutching means for its disengagement of said pulley from said motor.

14. A motorized curtain and blind tracking system according to claim 1, wherein said motor comprises multi electrical plug and said electrical connecting means comprise electrical multi receptacles mated with said plugs and extended to bottom & top of said driving terminal to electrically connect with said motor on bottom & top of said driving terminal.

15. A motorized curtain and blind tracking system according to claim 14, wherein said rotating output means are a shaft protruded out from said motor and said driving transmission means has thru hole along its rotating axis with shape matching the shape of said shaft for rotation driving.

16. A motorized curtain and blind tracking system according to claim 5, wherein said electrical connecting means comprise multiple receptacles which are AC Live, neutral for AC power connection.

17. A motorized curtain and blind tracking system according to claim 14 and 16, wherein said electrical connecting means comprise multiple receptacles with middle one is AC Live, symmetrically placed left and right of said middle one are both neutral and further symmetrically placed the second left and right are both Earth.

18. A motorized curtain and blind tracking system according to claim 1, wherein said electrical connecting means comprise multiple receptacles which are common or neutral, control signals for forward running and backward running of said motor.

19. A motorized curtain and blind tracking system according to claim 5 or 7, wherein said electrical connecting means comprise multiple receptacles with middle one is common, symmetrically placed on left and right of the said middle one is control signals for forward running and backward running of said motor.

20. A motorized curtain and blind tracking system according to claim 1, wherein said electrical connecting means comprise multiple receptacles which are DC direct and reverse control voltage to said motor for forward running and backward running.

21. A motorized curtain and blind tracking system according to claim 5 or 9, wherein said electrical connecting means comprise multiple receptacles with at least two symmetrically placed on left and right for DC direct and reverse control voltage to said motor for forward running and backward running.

22. A motorized curtain and blind tracking system according to claim 1, wherein said electrical connecting means comprise multiple receptacles which are positive DC voltage supply, DC common, and two DC motor control signals to said motor for forward running and backward running by indirect DC motor control.

23. A motorized curtain and blind tracking system according to claim 14 and 22, wherein said electrical connecting means comprise multiple receptacles with middle one is positive DC voltage supply, symmetrically placed at one position on left and right of the said middle one are both DC common, and symmetrically placed at the other position on left and right of the said middle one are divided into two top and bottom section with top left being the first one of said signals and top right being the second one of said signals, and with bottom left being the second one of signals and bottom right being the first one of said signals to said motor for forward running and backward running by indirect DC motor control.

24. A motorized curtain and blind tracking system according to claim 14, wherein on the top of said driving terminal there is a cover to cover said electrical connecting means.

25. A motorized curtain and blind tracking system comprising at least one motor each with rotating output means, driving carrier, end cap pulley terminal and driving terminal, a track with its two ends being connected with said end cap pulley terminal and driving terminal, and a completed looped belt or cable engaged with said end cap pulley terminal and driving terminal, placed inside said track and engaged with said driving carrier, said driving terminal comprising a housing and driving pulley mechanism, said driving pulley mechanism comprising motor engaging means to fix said motor with said driving terminal and to couple with said rotating output means for rotation to drive said belt or cable and also driving carrier moving along the said track, said track comprising two gliding channels, i.e., first and second gliding channel; two pairs of glides, i.e., first and second pair both moving along said first gliding channels; two glides of each pair being connected together by a holding track, the front glides of said first pair being engaged with said driving carrier, and front glides of said second pair being placed in front of the back glides of said first pair to enable said second pair to follow said first pair together with said driving carrier for forward movement, and being pushed back by said first pair together with said driving carrier for backward movement.

26. A motorized curtain and blind tracking system according to claim 12, wherein said track further comprise at least one more pairs of glides, i.e. third pair, being connected by another holding track and moving on said second gliding channel, and each said glides of said second pair comprises a driving link; the front glides of said third pair comprises a driving section being extruded out toward said first gliding channel and is place between said driving links to enable said third pair to follow said first and second pair together with said driving carrier for forward movement, and is pushed back by said second pair together for backward movement.

27. A motorized curtain and blind tracking system according to claim 1, wherein said driving terminal comprises adapting mean for mounting decoration finial on the other end to one connected with said track.

28. A motorized curtain and blind tracking system comprising at least one motor each with rotating output means, driving carrier, end cap pulley terminal and driving terminal, a track with its two ends being connected with said end cap pulley terminal and driving terminal, and a completed looped belt or cable engaged with said end cap pulley terminal and driving terminal, placed inside said track and engaged with said driving carrier, said driving terminal comprising a housing and driving pulley mechanism, said driving pulley mechanism comprising motor engaging means to fix said motor with said driving terminal and to couple with said rotating output means for rotation to drive said belt and also driving carrier moving along the said track, said belt being T shaped toothed belt, and said track comprising a series of carriers comprising gear transmission means with its first gear being engaged with said belt, and said carriers comprising a hook for vertical blind vanes hanging, and said hook being engaged with the last gear and rotated thru said gear transmission means by movement of said belt.

29. A motorized curtain and blind tracking system according to claim 14, wherein said belt comprises connecting mean for its two ends to form a complete loop inside said track, said connecting means comprise a top and bottom covers with same T shaped tooth coupled with those of two ends of said T shaped toothed belt, and said top and bottom covers comprise locking mean to lock themselves together.

30. A motorized curtain and blind tracking system according to claim 14, wherein said carriers are linked with a series of button with a string for even spacing of blind vanes.

31. A motorized curtain and blind tracking system according to claim 14, wherein said T shaped toothed belt comprises a carrier driving means having multi same T shaped tooth coupled with those of T shaped toothed belt, and along the engaged said T shaped tooted belt having front driving section at its front and back driving section at its back, and said driving carrier is one of said series of carriers at front and comprises driving pusher extruded toward to said driving mean and moves between said front and back driving sections for open and close operation of vertical blind.

32. A motorized curtain and blind tracking system comprising at least one motor each with rotating output means, driving carrier, end cap pulley terminal and driving terminal, a track with its two ends being connected with said end cap pulley terminal and driving terminal, and a completed looped belt or cable engaged said end cap pulley terminal and driving terminal, placed inside said track and engaged with said driving carrier, said driving terminal comprising a housing and driving pulley mechanism, said driving pulley mechanism comprising motor engaging means to fix said motor with said driving terminal and to couple with said rotating output means for rotation to drive said belt or cable and also driving carrier moving along the said track, said driving terminal comprising adapting mean for mounting decoration finial on the other end to one connected with said track, a series of decorative rings being placed around said track, said driving carrier comprising ring engaging means to be fixed with one or more of said rings at front.

33. Motorized curtain and blind tracking systems comprising common features as follows:
at least one motor each with rotating output means, driving carrier, end cap pulley terminal and driving terminal, a track with its two ends being connected with said end cap pulley terminal and driving terminal, and a completed looped belt or cable engaged with said end cap pulley terminal and driving terminal, placed inside said track and engaged with said driving carrier, said driving terminal comprising a housing and driving pulley mechanism, said driving pulley mechanism comprising motor engaging means to fix said motor with said driving terminal and to couple with said rotating output means for rotation to drive said belt or cable and also driving carrier moving along the said track, including following systems with different features and structure for different applications, and said driving terminals of at least two of said following systems comprising identical motor engaging means to fix same motor with said driving terminals and to couple with same rotating output means of said motor for rotation:
I. said track of the first system comprising a series of carriers for hanging normal curtain fabric,
II. said track of the second system comprising two gliding channels, i.e., first and second gliding channel; two pairs of glides, i.e., first and second pair both moving along said first gliding channels; two glides of each pair being connected together by a holding track, the front glides of said first pair being engaged with said driving carrier, and front glides of said second pair being placed in front of the back glides of said first pair to enable said second pair to follow said first pair together with said driving carrier for forward movement, and being pushed back by said first pair together with said driving carrier for backward movement.
III. said belt of the third system being T shaped toothed belt, and said track comprising a series of carriers comprising gear transmission means with its first gear being engaged with said belt, and said carriers comprising a hook for vertical blind vanes hanging, and said hook being engaged with the last gear and rotated thru said gear transmission means by movement of said belt.
IV. said driving terminal of the fourth system comprising adapting mean for mounting decoration finial on the other end to one connected with said track, a series of decorative rings being placed around said track, said driving carrier comprising ring engaging means to be fixed with one or more of said rings at front.

34. Motorized curtain and blind tracking system according to claim 19, wherein said driving terminals comprise controller circuit and electrical connecting means to connect said motor.

35. A motorized curtain and blind tracking system comprising control circuits, a least one motor each with rotating output means, driving carrier, end cap pulley terminal and driving terminal, a track with its two ends being connected with said end cap pulley terminal and driving terminal, and a completed looped belt or cable engaged with said end cap pulley terminal and driving terminal, placed inside said track and engaged with said driving carrier, said driving terminal comprising a housing and driving pulley mechanism, said driving pulley mechanism comprising motor engaging means to fix said motor with said driving terminal and to couple with said rotating output means for rotation to drive said belt or cable and also driving carrier moving along the said track, said driving carrier comprising at least one adapting glide and main body with a adapting base to be fixed with said adapting glide by a screw or rivet, said belt comprising belt engaging means to be engaged with said driving carrier.

36. A motorized curtain and blind tracking system according to claim 34, wherein said adapting glide comprises top opening and said belt engaging mean is inserted into the opening from the top.
